(19) United States
(12) Patent Application Publication
(10) Pub. No.: US 2017/0040828 A1
(43) Pub. Date: Feb. 9, 2017

(54) WIRELESS CHARGING DEVICE WITH CIRCUIT ELECTRICALLY COUPLEABLE TO FIRST AND SECOND COILS

(71) Applicant: Lenovo (Singapore) Pte, Ltd., New Tech Park (SG)

(72) Inventors: Jeremy Robert Carlson, Cary, NC (US); Philip John Jakes, Durham, NC (US); Larry Glenn Estes, Durham, NC (US)

(21) Appl. No.: 14/820,850

(22) Filed: Aug. 7, 2015

(51) Int. Cl. H02J 7/02; B60L 11/18; B60R 16/033

(52) U.S. Cl. CPC H02J 7/025; B60R 16/033; B60L 11/182

(57) ABSTRACT

In one aspect, a wireless charge receiver includes a first coil, a second coil, and a circuit operatively coupleable to the first coil and the second coil. The circuit couples and decouples from being able to receive power from the first coil and the second coil based on at least one parameter.

### FIELD

The present application relates generally wireless charging devices with a circuit electrically coupleable to first and second coils.

### BACKGROUND

Wireless charging devices are increasing in prevalence. However, as recognized herein, wireless charge receivers are typically arranged on information handling systems to receive a wireless charge from a wireless charge transmitter while the information handling system is in but one physical orientation relative to the wireless charge transmitter. As also recognized herein, this can be problematic to a user when such an information handling system is a so-called “convertible” device and the user wishes to charge in more than one configuration of this device and hence more than one physical orientation.

### SUMMARY

Accordingly, in one aspect a device includes system components, a battery which supplies power to the system components, and at least one wireless charge receiver that charges the battery while influenced by a magnetic field of a wireless charge transmitter. The at least one wireless charge receiver comprises a circuit coupled to the battery, a first coil coupled to the circuit, and a second coil coupled to the circuit. The device also includes at least one magnetic field barrier at least in part separating the first coil from the second coil.

In another aspect, a method includes electrically decoupling a first coil from providing power to a circuit of a wireless charge receiver based on a first factor and electrically decoupling a second coil different from the first coil from providing power to the circuit based on a second factor different from the first factor.

In still another aspect, a wireless charge receiver comprises a first coil, a second coil, and a circuit operatively coupleable to the first coil and the second coil. The circuit couples and decouples from being able to receive power from the first coil and the second coil based on at least one parameter.

The details of present principles, both as to their structure and operation, can best be understood in reference to the accompanying drawings, in which like reference numerals refer to like parts, and in which:

### BRIEF DESCRIPTION OF THE DRAWINGS

FIG. 1 is a block diagram of an example system in accordance with present principles;

FIG. 2 is a block diagram of a network of devices in accordance with present principles;

FIGS. 3-5 are flow charts showing example algorithms in accordance with present principles;

FIGS. 6-9 are side elevational views of example devices in accordance with present principles; and

FIGS. 10-11 are example user interfaces (UIs) in accordance with present principles.

### DETAILED DESCRIPTION

This disclosure relates generally to device-based information. With respect to any computer systems discussed herein, a system may include server and client components, connected over a network such that data may be exchanged between the client and server components. The client components may include one or more computing devices including televisions (e.g., smart TVs, Internet-enabled TVs), computers such as desktops, laptops and tablet computers, so-called convertible devices (e.g., having a tablet configuration and laptop configuration), and other mobile devices including smart phones. These client devices may employ, as non-limiting examples, operating systems from Apple, Google, or Microsoft. A Unix or similar such as Linux operating system may be used. These operating systems can execute one or more browsers such as a browser made by Microsoft or Google or Mozilla or other browser program that can access web applications hosted by the Internet servers over a network such as the Internet, a local intranet, or a virtual private network.

As used herein, instructions refer to computer-implemented steps for processing information in the system. Instructions can be implemented in software, firmware or hardware; hence, illustrative components, blocks, modules, circuits, and steps are set forth in terms of their functionality.

A processor may be any conventional general purpose single- or multi-chip processor that can execute logic by means of various lines such as address lines, data lines, and control lines and registers and shift registers. Moreover, any logical blocks, modules, and circuits described herein can be implemented or performed, in addition to a general purpose processor, in or by a digital signal processor (DSP), a field programmable gate array (FPGA) or other programmable logic device such as an application specific integrated circuit (ASIC), discrete gate or transistor logic, discrete hardware components, or any combination thereof designed to perform the functions described herein. A processor can be implemented by a controller or state machine or a combination of computing devices.

Any software and/or applications described by way of flow charts and/or user interfaces herein can include various sub-routines, procedures, etc. It is to be understood that logic divulged as being executed by, e.g., a module can be redistributed to other software modules and/or combined together in a single module and/or made available in a shareable library.

Logic when implemented in software, can be written in an appropriate language such as but not limited to C# or C++, and can be stored on or transmitted through a computer-readable storage medium (e.g., that may not be a transitory signal) such as a random access memory (RAM), read-only memory (ROM), electrically erasable programmable read-only memory (EEPROM), compact disk read-only memory (CD-ROM) or other optical disk storage such as digital versatile disc (DVD), magnetic disk storage or other magnetic storage devices including removable thumb drives, etc. A connection may establish a computer-readable medium. Such connections can include, as examples, hard-wired cables including fiber optics and coaxial wires and twisted pair wires. Such connections may include wireless communication connections including infrared and radio.

In an example, a processor can access information over its input lines from data storage, such as the computer readable storage medium, and/or the processor can access information wirelessly from an Internet server by activating a wireless transceiver to send and receive data. Data typically is converted from analog signals to digital by circuitry between the antenna and the registers of the processor when being received and from digital to analog when being transmitted. The processor then processes the data through its shift registers to output calculated data on output lines, for presentation of the calculated data on the device.

Components included in one embodiment can be used in other embodiments in any appropriate combination. For example, any of the various components described herein and/or depicted in the Figures may be combined, interchanged or excluded from other embodiments.

“A system having at least one of A, B, and C” (likewise “a system having at least one of A, B, or C” and “a system having at least one of A, B, C”) includes systems that have A alone, B alone, C alone, A and B together, A and C together. B and C together, and/or A. B, and C together, etc.

“A system having one or more of A, B, and C” (likewise “a system having one or more of A, B, or C” and “a system having one or more of A, B, C”) includes systems that have A alone, B alone, C alone, A and B together, A and C together, B and C together, and/or A, B, and C together, etc.

The term “circuit” or “circuitry” is used in the summary, description, and/or claims. As is well known in the art, the term “circuitry” includes all levels of available integration, e.g., from discrete logic circuits to the highest level of circuit integration such as VLSI, and includes programmable logic components programmed to perform the functions of an embodiment as well as general-purpose or special-purpose processors programmed with instructions to perform those functions.

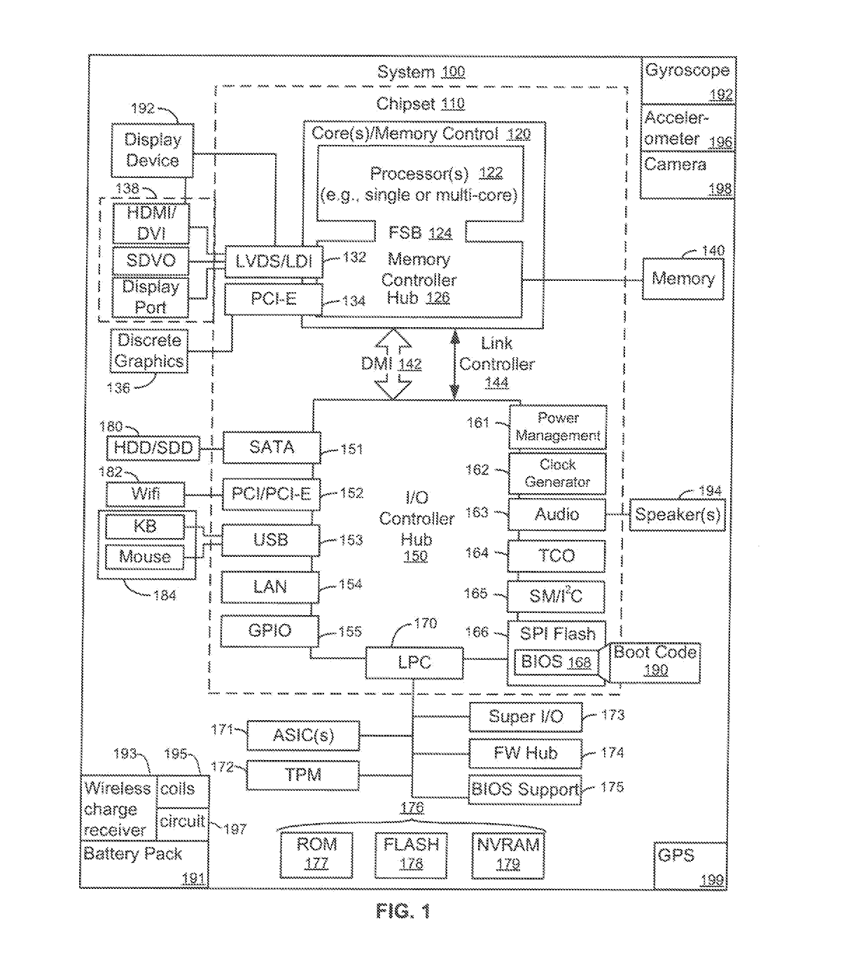

Now specifically in reference to FIG. 1, it shows an example block diagram of an information handling system and/or computer system 100. Note that in some embodiments the system 100 may be a desktop computer system, such as one of the ThinkCentre® or ThinkPad® series of personal computers sold by Lenovo (US) Inc. of Morrisville, N.C., or a workstation computer, such as the Yoga™ series of convertible computers or a ThinkStation@, which are sold by Lenovo (US) Inc. of Morrisville, N.C.; however, as apparent from the description herein, a client device, a server or other machine in accordance with present principles may include other features or only some of the features of the system 100. Also, the system 100 may be, e.g., a game console such as XBOX® or Playstation®.

As shown in FIG. 1, the system 100 includes a so-called chipset 110. A chipset refers to a group of integrated circuits, or chips, that are designed to work together. Chipsets are usually marketed as a single product (e.g., consider chipsets marketed under the brands INTEL®, AMD®, etc.).

In the example of FIG. 1, the chipset 110 has a particular architecture, which may vary to some extent depending on brand or manufacturer. The architecture of the chipset 110 includes a core and memory control group 120 and an I/O controller hub 150 that exchange information (e.g., data, signals, commands, etc.) via, for example, a direct management interface or direct media interface (DMI) 142 or a link controller 144. In the example of FIG. 1, the DMI 142 is a chip-to-chip interface (sometimes referred to as being a link between a “northbridge” and a “southbridge”).

The core and memory control group 120 include one or more processors 122 (e.g., single core or multi-core, etc.) and a memory controller hub 126 that exchange information via a front side bus (FSB) 124. As described herein, various components of the core and memory control group 120 may be integrated onto a single processor die, for example, to make a chip that supplants the conventional “northbridge” style architecture.

The memory controller hub 126 interfaces with memory 140. For example, the memory controller hub 126 may provide support for DDR SDRAM memory (e.g., DDR, DDR2, DDR3, etc.). In general, the memory 140 is a type of random-access memory (RAM). It is often referred to as “system memory.”

The memory controller hub 126 further includes a low-voltage differential signaling interface (LVDS) 132. The LVDS 132 may be a so-called LVDS Display Interface (LDI) for support of a display device 192 (e.g., a CRT, a flat panel, a projector, a touch-enabled display, etc.). A block 138 includes some examples of technologies that may be supported via the LVDS interface 132 (e.g., serial digital video, HDMI/DVI, display port). The memory controller hub 126 also includes one or more PCI-express interfaces (PCI-E) 134, for example, for support of discrete graphics 136. Discrete graphics using a PCI-E interface has become an alternative approach to an accelerated graphics port (AGP). For example, the memory controller hub 126 may include a 16-lane (×16) PCI-E port for an external PCI-E-based graphics card (including, e.g., one of more GPUs). An example system may include AGP or PCI-E for support of graphics.

The I/O hub controller 150 includes a variety of interfaces. The example of FIG. 1 includes a SATA interface 151, one or more PCI-E interfaces 152 (optionally one or more legacy PCI interfaces), one or more USB interfaces 153, a LAN interface 154 (more generally a network interface for communication over at least one network such as the Internet, a WAN, a LAN, etc. under direction of the processor(s) 122), a general purpose I/O interface (GPIO) 155, a low-pin count (LPC) interface 170, a power management interface 161, a clock generator interface 162, an audio interface 163 (e.g., for speakers 194 to output audio), a total cost of operation (TCO) interface 164, a system management bus interface (e.g., a multi-master serial computer bus interface) 165, and a serial peripheral flash memory/controller interface (SPI Flash) 166, which, in the example of FIG. 1, includes BIOS 168 and boot code 190. With respect to network connections, the I/O hub controller 150 may include integrated gigabit Ethernet controller lines multiplexed with a PCI-E interface port. Other network features may operate independent of a PCI-E interface.

The interfaces of the I/O hub controller 150 provide for communication with various devices, networks, etc. For example, the SATA interface 151 provides for reading, writing or reading and writing information on one or more drives 180 such as HDDs, SDDs or a combination thereof, but in any case the drives 180 are understood to be, e.g., tangible computer readable storage mediums that may not be transitory signals. The I/O hub controller 150 may also include an advanced host controller interface (AHCI) to support one or more drives 180. The PCI-E interface 152 allows for wireless connections 182 to devices, networks, etc. The USB interface 153 provides for input devices 184 such as keyboards (KB), mice and various other devices (e.g., cameras, phones, storage, media players, etc.).

In the example of FIG. 1, the LPC interface 170 provides for use of one or more ASICs 171, a trusted platform module (TPM) 172, a super 1/O 173, a firmware hub 174, BIOS support 175 as well as various types of memory 176 such as ROM 177, Flash 178, and non-volatile RAM (NVRAM) 179. With respect to the TPM 172, this module may be in the form of a chip that can be used to authenticate software and hardware devices. For example, a TPM may be capable of performing platform authentication and may be used to verify that a system seeking access is the expected system.

The system 100, upon power on, may be configured to execute boot code 190 for the BIOS 168, as stored within the SPI Flash 166, and thereafter processes data under the control of one or more operating systems and application software (e.g., stored in system memory 140). An operating system may be stored in any of a variety of locations and accessed, for example, according to instructions of the BIOS 168.

Furthermore, the system 100 may also include at least one battery pack 191 comprising at least one battery. The battery pack 191 is electrically coupled to and powers the system 100, and is also electrically coupled to at least one wireless charge receiver 193 that is configured for receiving a wireless charge via a magnetic field from a wireless charge transmitter (not shown) using. e.g., inductive wireless charging principles and/or resonant inductive coupling principles. Thus, the receiver 193 may comprise plural coils 195. The coils 195 may respectively comprise at least one wire disposed around a magnet, and may be configured for receiving power from the wireless charge transmitter via the magnetic/electromagnetic field created by the transmitter when activated. The receiver 193 also includes at least one circuit 197 (in some embodiments only one circuit may be included, while in other embodiments plural circuits may be included) configured for receiving current from the coils 195 and doing at least one of: providing current to the system 100 to power it and providing current to the battery pack 191 to charge at least one battery in the pack 191. The circuit 197 may be an Rx circuit, and/or the circuit 197 may be comprised of one or more of a converter(s), a regulator(s), and/or a communicator(s).

Additionally, the system 100 may include a gyroscope 192 for sensing and/or measuring the orientation of the system 100 and providing input related thereto to the processor 122, an accelerometer 196 for sensing acceleration and/or movement of the system 100 and providing input related thereto to the processor 122, and a camera 198 for gathering one or more images and providing input related thereto to the processor 122. The camera may be a thermal imaging camera, a digital camera such as a webcam, a three-dimensional (3D) camera, and/or a camera otherwise integrated into the system 100 and controllable by the processor 122 to gather pictures/images and/or video. Still further, the system 100 may include a GPS transceiver 199 that is configured to receive geographic position information from at least one satellite and provide the information to the processor 122. However, it is to be understood that another suitable position receiver other than a GPS receiver may be used in accordance with present principles to determine the location of the system 100.

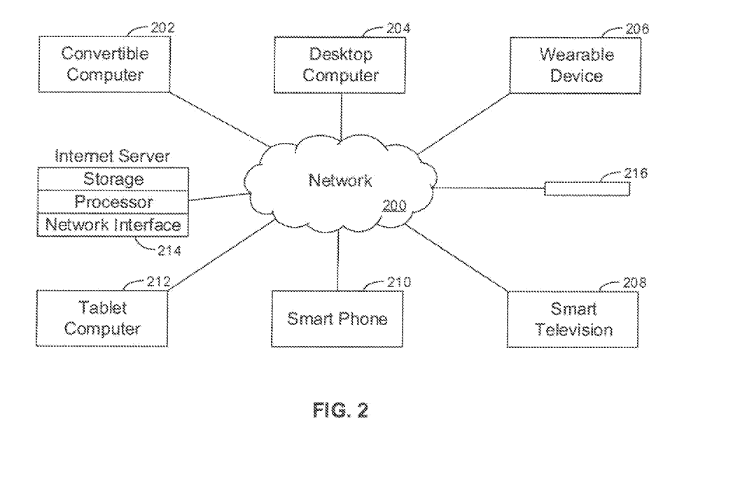

Before moving on to FIG. 2, it is to be understood that an example client device or other machine/computer may include fewer or more features than shown on the system 100 of FIG. 1. In any case, it is to be understood at least based on the foregoing that the system 100 is configured to undertake present principles.

Turning now to FIG. 2, it shows example devices communicating over a network 200 such as the Internet in accordance with present principles. It is to be understood that each of the devices described in reference to FIG. 2 may include at least some of the features, components, and/or elements of the system 100 described above. In any case, FIG. 2 shows a notebook computer and/or convertible computer 202, a desktop computer 204, a wearable device 206 such as a smart watch, a smart television (TV) 208, a smart phone 210, a tablet computer 212, and a server 214 such as an Internet server that may provide cloud storage accessible to the devices 202-212.

Also shown in FIG. 2 is a wireless charge transmitter 216 configured for providing, to a wireless charge receiver, a wireless charge via a magnetic field using, e.g., inductive wireless charging principles and/or resonant inductive coupling principles. Thus, the wireless charge transmitter 216 may comprise at least one coil for undertaking present principles, and may be engaged (e.g., conductively coupled) to a wall outlet or other power source. It is to be understood that the devices 202-216 are configured to communicate with each other over the network 200.

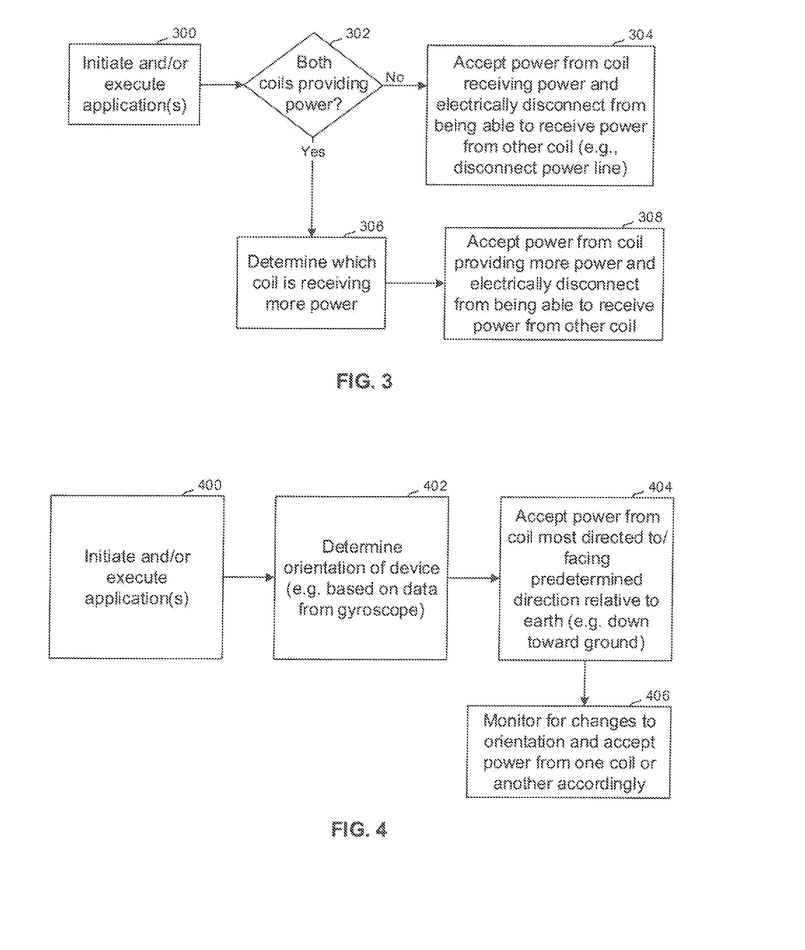

Referring now to FIG. 3, it shows example logic that may be undertaken by a device such as the system 100 in accordance with present principles (referred to below as the “present device”). The example logic of FIG. 3 may be executed by the present device to determine which of at least two coils disposed in the present device should be used for wireless charging. Beginning at block 300, the logic initiates and/or executes one or more applications for undertaking present principles, such as a wireless charging application, a power management application, etc.

The logic then proceeds to decision diamond 302, where the logic determines whether both (or optionally, more than two) wireless charging receiver coils disposed in the present device are providing power to a single wireless charge receiver circuit. The determination made at diamond 302 may be based on identification of receipt of power (e.g., using a current sensor in the present device, and/or a resistor or a transformer at the circuit) over different power supply lines respectively connected to different ones of the at least two coils and that are both connected to the circuit. In response to a negative determination at diamond 302, the logic proceeds to block 304 where the logic configures the circuit and hence wireless charge receiver to accept power from a single coil that is providing power (or from no coil at all if none are providing power) and to electrically disconnect from being able to receive power from one or more other coils on the present device, such as by electrically disconnecting all lines (e.g., power supply lines, communication lines, etc.) from the circuit to the other coil and/or by electrically disconnecting a power supply line specifically and/or only.

However, note that an affirmative determination at diamond 302 instead causes the logic to proceed to block 306 where the logic determines which coil of the at least two coils connected to the circuit is currently capable of providing more power to the circuit (e.g., as may be the case based on the current physical orientation and/or configuration of the present device relative to an active wireless charge transmitter). The determination made at block 306 may be executed based on identification of amounts of power currently capable of being received at the circuit from each of the coils over respective power supply lines as detected using a current sensor, resistor, and/or transformer in the present device such as in or near the circuit itself. From block 306 the logic proceeds to block 308. At block 308 the logic accepts power from the coil providing the most power as determined at block 306 and electrically disconnects all lines (e.g., power supply lines, communication lines, etc.) from the circuit to the other coil or electrically disconnects a power supply line specifically and/or only.

Now in reference to FIG. 4, it also shows example logic that may be undertaken by a device such as the system 100 in accordance with present principles (referred to below as the “present device”). The example logic of FIG. 4 may be executed by the present device to determine which of at least two coils disposed in the present device should be used for wireless charging, this time based on device orientation. For instance, one coil may be closer to where a wireless charge transmitter is, or is expected to be, relative to the present device to provide a wireless charge based on a particular orientation of the convertible present device.

Beginning at block 400, the logic of FIG. 4 initiates and/or executes one or more applications for undertaking present principles, such as a wireless charging application, a power management application, a gyroscope application, etc. The logic then moves to block 402 where the logic determines an orientation of the device, such as relative to earth and/or relative to the direction of the earth's gravity, based on data from one or more sensors on the present device such as a gyroscope and/or accelerometer, and/or based on images from a camera to identify the orientation using object recognition.

From block 402 the logic moves to block 404 where the logic configures, based on the determined orientation, the wireless charge receiver of the present device (e.g., configures the circuit specifically) to accept power from a coil on the present device most directed to and/or facing a predetermined direction (e.g., relative to the earth) from which a wireless charge is to be received.

For instance, the present device may be configured for wireless charging by placing the present device on top of a wireless charge transmitter which is itself disposed on a flat surface such as a table top. Accordingly, the logic may determine the physical orientation of the device, identify which of at least two coils is nearest to the bottom of the present device relative to earth in the current orientation, and/or facing beneath the present device relative to earth in the current orientation, and then accept power from that nearest and/or downward facing coil. The logic may then conclude at block 406 where the logic monitors for changes to the orientation and accepts power from an appropriate coil accordingly, such as by repeating the actions taken at block 402 and 404 and possibly switching coils by electrically decoupling from receiving power from one while electrically coupling to another for receiving power therefrom (e.g., by controlling one or more electrical bridges and/or gates in the power supply lines and/or between the power supply lines and the circuit).

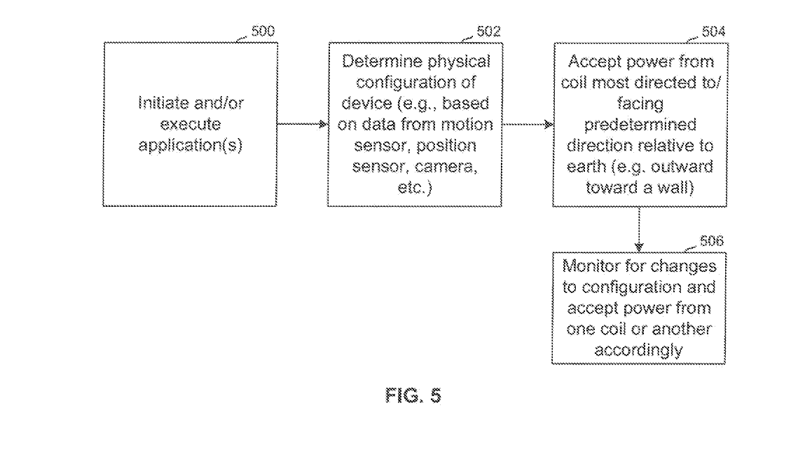

Moving on to the description of FIG. 5, it shows example logic that may be undertaken by a device such as the system 100 in accordance with present principles (referred to below as the “present device”). The example logic of FIG. 5 may be executed by the present device to determine which of at least two coils disposed in the present device should be used for wireless charging based on physical configuration and/or arrangement (referred to below simply as “configuration” for simplicity) of one portion of the device relative to another portion. For instance, one coil may be closer to where a wireless charge transmitter is, or is expected to be, relative to the present device to provide a wireless charge based on a particular configuration of the convertible present device. Example physical configurations include a tent configuration establishing an A-frame with a display facing outward, a tablet configuration in which a display on one panel of the present device faces an opposite direction as a keyboard on another panel, a laptop configuration analogous to many traditional laptops when opened, and a stand configuration in which the keyboard side of one panel is placed on a surface while a display side of another panel faces away from the keyboard panel along a plane intersecting a plane established by the surface.

In any case, the logic of FIG. 5 begins at block 500 where the logic initiates and/or executes one or more applications for undertaking present principles, such as a wireless charging application, a power management application, a position sensor and/or GPS application, an inertial sensor and/or accelerometer application, a light-based motion sensor application, a camera application, etc. The logic then moves to block 502 where the logic determines a configuration of the device based on data from one or more sensors such as an inertial sensor or accelerometer, position data from respective GPS transceivers on portions of the present device that move relative to each other to establish various configurations, based on data from a light-based motion sensor detecting direction of movement of one portion of the present device relative to another portion on which the light-based motion sensor is disposed, and/or based on images from a camera to identify the configuration by identifying another portion of the device and its orientation (e.g., using object recognition) relative to the portion of the present device on which the camera is disposed.

From block 502 the logic moves to block 504 where the logic configures, based on the determined configuration, the wireless charge receiver of the present device (e.g., configures the circuit specifically) to accept power from a coil on the present device most directed to and/or facing a predetermined direction from which a wireless charge is to be received.

For instance, the present device may be configured for wireless charging by placing the present device against a wireless charge transmitter disposed on a vertical surface such as a wall. Accordingly, the logic may determine the configuration of the device, identify which of at least two coils is nearest to an exterior face of the present device in the current configuration and/or facing outward in the current configuration, and then accept power from that exterior facing coil. The logic may then conclude at block 506 where the logic monitors for changes to the configuration of the convertible present device and accepts power from an appropriate coil accordingly, such as by repeating the actions taken at block 502 and 504 and possibly switching coils by electrically decoupling from receiving power from one while electrically coupling to another for receiving power therefrom (e.g., by controlling one or more electrical bridges and/or gates in the power supply lines and/or between the power supply lines and the circuit).

Before moving on to the description of other figures, it is to be understood that the logic of FIGS. 3-5 may be executed in isolation or in combination with each other. For instance, after determining that two of three coils connected to a circuit on the present device both face a same predetermined direction at block 504, the logic may determine which of the two coils is capable of providing more power such as described above in reference to block 306 and accept power from that coil capable of providing the most power. As another example, if device orientation and/or configuration cannot be determined, the logic may then identify which of plural coils on the device is currently capable of providing more power and accept power only from that coil. As but one more example, if device orientation and configuration are determined, the logic may identify which of plural coils on the device to use to charge the device's battery based on which coil is, based on orientation and configuration, nearest to where a wireless charge transmitter is expected to be located for charging (e.g., beneath the device in its current orientation and configuration).

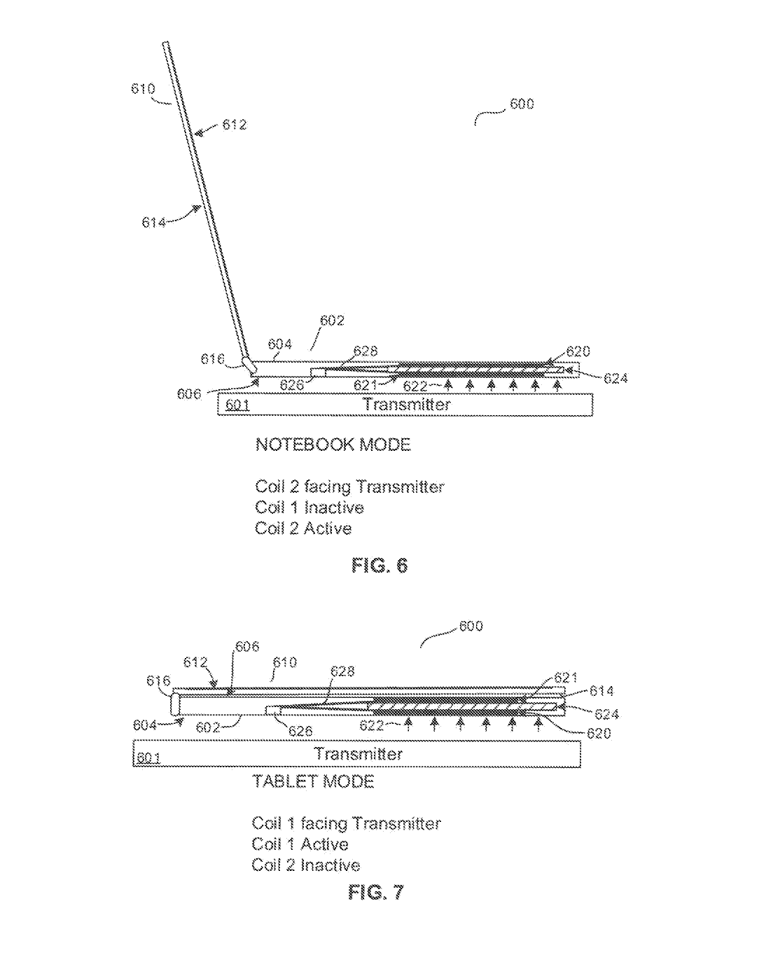

Continuing the detailed description in cross-reference to FIGS. 6-8, they show respective side elevational views (with portions cut away for clarity) of a convertible computing device 600 and a wireless charge transmitter 601. In some example embodiments, the device 600 may be a Lenovo Yoga series convertible computer. In any case, the device 600 has a first panel 602 housing one or more system components such as those described above in reference to the system 100. The first panel 602 also has a first face 604 that bears a keyboard and is analogous to one established by an upper face of a bottom panel of a laptop computer that typically bears a keyboard. The first panel 602 also includes a second face 606 opposite the first face 604.

The device 600 also has a second panel 610 housing one or more system components, such as a display on a first face 612 that is analogous to one established by a front face of a top panel of a laptop computer that typically bears a display. The second panel 610 also has a second face 614 opposite the first face 612. As may also be appreciated from these figures, the first panel 602 is coupled to the second panel 610 at a junction 616, which in the present example may be a hinge, for rotating the first panel 602 relative to the second panel 610, or vice versa, around an axis established by a lengthwise dimension of the junction 616 going from one side of each respective panel 602, 610 to the other respective side of each panel 602, 610 (such as the sides for the respective panels shown in the side elevational views of FIGS. 6-8).

It is to be understood that either or both of the panels 602 and 610 may be detachable from the junction 616 and hence detachable from each other to convert between, e.g., a laptop configuration for the device 600 as shown in FIG. 6 and a tablet-only configuration (not shown) in which the panel 610 may stand alone and function as a touch-enabled tablet computer without the panel 602. Furthermore, the junction 616 may be configured for facilitating rotation of the first panel 602 relative to the second panel 610 (when joined at the junction 616) around the axis established by the length of the junction 616 such that the device 600 may be transitioned between various configurations including a laptop configuration (FIG. 6), a tablet configuration (FIG. 7), and a tent configuration (FIG. 8). As may be appreciated from FIG. 6, in the laptop configuration the panels 602 and 610 are coupled to each other (via the junction 616) and the face 612 bearing the display faces a direction at least partially toward the panel 602 so that a user may view content on the display from in front of the panel 602 while at least coil 621 (and in some embodiments, coil 620 too, though it may be electrically decoupled based on the determinations discussed herein, such as those discussed in reference to FIGS. 3-5) is affected by a magnetic field 622 created by the wireless charge transmitter 601 to wirelessly charge a battery disposed in the device 600 in accordance with present principles (e.g., using inductive charging).

As may be appreciated from FIG. 7, in the tablet configuration the panels 602, 610 are still coupled to each other (via the junction 616) and the face 612 bearing the display faces a direction opposite the direction of the transmitter 601 relative to the device 600 so that a user may view content on the display from above the device 600 while at least coil 620 (and in some embodiments, coil 621 too, though it may be electrically decoupled based on the determinations discussed herein, such as those discussed in reference to FIGS. 3-5) is affected by the magnetic field 622 created by the wireless charge transmitter 601 to wirelessly charge a battery disposed in the device 600 in accordance with present principles.

As may be appreciated from FIG. 8, in the tent configuration the panels 602, 610 are coupled to each other (via the junction 616) and the face 612 bearing the display faces a direction exterior to and/or away from the device 600) so that a user may view content on the display from in front of the face 612 while at least coil 621 (and in some embodiments, coil 620 too, though it may be electrically decoupled based on the determinations discussed herein, such as those discussed in reference to FIGS. 3-5) is affected by the magnetic field 622 created by the wireless charge transmitter 601 to wirelessly charge a battery disposed in the device 600 in accordance with present principles.

Still in reference to FIGS. 6-8, note that the panel 602 may (though it need not necessarily) include at least one shield and/or barrier 624 (which may be comprised at least partially of a ceramic such as ferrite and may be disposed between and/or separate the coils 620, 621 in the example shown) for at least partially shielding components of the device 600 (e.g., metal-based electronics) from the magnetic field 622 when in various configurations as described herein (and/or otherwise directing magnetic flux away from these components), and for directing and/or concentrating magnetic flux toward the coils 620, 621 for wireless charging. However, first note that each of the coils 620, 621 are electrically coupled to a circuit 626 via one or more lines 628, such as a communication line and/or a power supply line, or a single line for both communication and power supply.

Thus, the circuit 626 is configured to operatively connect and disconnect from receiving power from each of the coils 620, 621. For instance, the circuit 626 may electrically couple and decouple altogether from each of the coils 620, 621 via lines 628 (e.g., even if still mechanically coupled), and/or may electrically couple and decouple via a power supply line specifically (or a power supply portion of a single line for both communication and power supply) for each of the coils 620, 621 while remaining communicatively coupled thereto, such as for repeated determinations of which of the coils 620, 621 is capable of providing more power in accordance with present principles and switching coils accordingly to charge a battery on the device 600.

It is to be understood that the coils 620, 621, circuit 626, and lines 628 thus establish one example embodiment of a wireless charge receiver in accordance with present principles. In some embodiments, the shield 624 may also form part of the wireless charge receiver while in other embodiments it may not, though it may still be present. In any case, based on the field 622 affecting one or both of the coils 620, 621 for the coils to thereby provide power to the circuit 626, the wireless charge receiver charges a battery in the device 600 (not shown for clarity) connected to the circuit 626 under control of the wireless charge receiver (e.g., under control of a processor therein such as in/connected to the circuit 626 itself), under control of a power management integrated circuit in the device 600, and/or under control of another processing component such as a central processing unit (CPU) in the device 600. In addition to or in lieu of the foregoing, the wireless charge receiver may charge the battery using other hardware-based methods, such as using a comparator in the device 600 to sense which coil is able to provide more power (and/or has a higher voltage) to thus determine which of the coils 620, 621 to use in accordance with present principles.

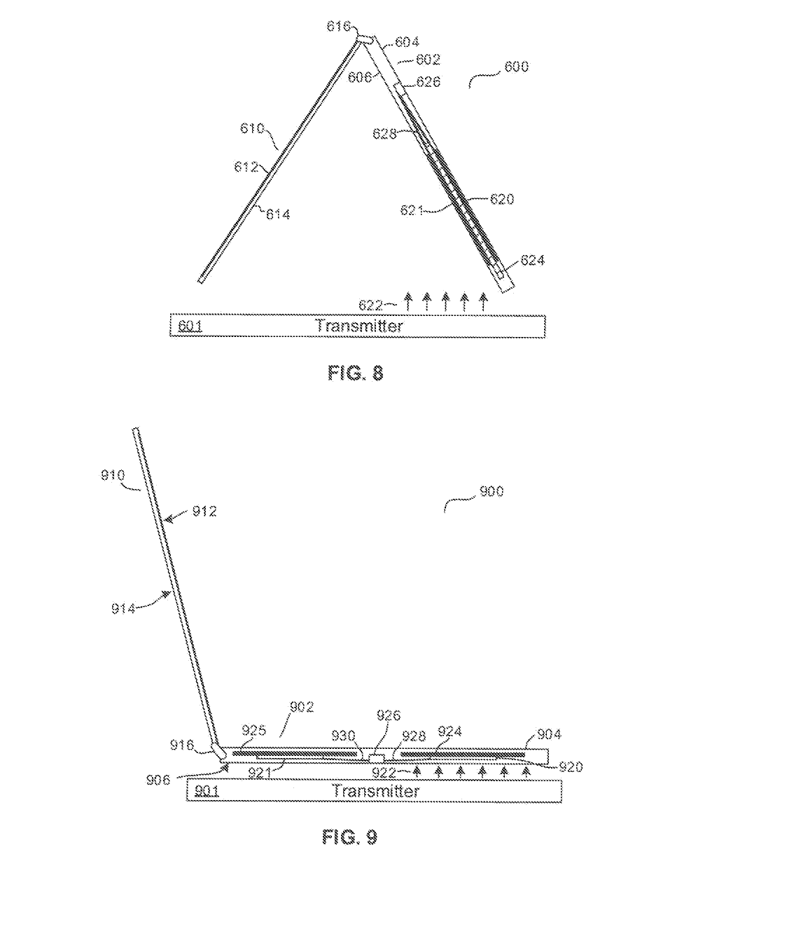

Now in reference to FIG. 9, it shows another example embodiment in accordance with present principles. The side elevational view shown is of a convertible computing device 900 and a wireless charge transmitter 901. In some example embodiments, the device 900 may be a Lenovo Yoga series convertible computer. In any case, the device 900 has a first panel 902 housing one or more system components such as those described above in reference to the system 100. The first panel 902 also has a first face 904 that bears a keyboard and is analogous to one established by an upper face of a bottom panel of a laptop computer that typically bears a keyboard. The first panel 902 also includes a second face 906 opposite the first face 904.

The device 900 also has a second panel 910 housing one or more system components, such as a display on a first face 912 that is analogous to one established by a front face of a top panel of a laptop computer that typically bears a display. The second panel 910 also has a second face 914 opposite the first face 912. As may also be appreciated from these figures, the first panel 902 is coupled to the second panel 910 at a junction 916, which in the present example may be a hinge, for rotating the first panel 902 relative to the second panel 910, or vice versa, around an axis established by a lengthwise dimension of the junction 916 going from one side of each respective panel 902, 910 to the other respective side of each panel 902, 910.

It is to be understood that either or both of the panels 902 and 910 may be detachable from the junction 916 and hence detachable from each other to convert between various configurations such as those described above. A laptop configuration for the device 900 is shown in FIG. 9, but regardless, the junction 916 may be configured for facilitating rotation of the first panel 902 relative to the second panel 910 (when joined at the junction 916) around the axis established by the length of the junction 916 such that the device 900 may be transitioned between various configurations such as those disclosed herein (e.g., a laptop configuration, a tablet configuration, a tent configuration, and a stand configuration).

The device 900 also includes two coils 920 and 921 each respectively associated with a magnetic field barrier 924 and 925 and each effected by a magnetic field 922 created by the wireless charge transmitter 901 to wirelessly charge a battery disposed in the device 900 in accordance with present principles (e.g., using inductive charging). The barriers 924, 925 may be comprised at least partially of a ceramic such as ferrite and may be respectively disposed adjacent to and/or against the coils 920, 921 for at least partially shielding components of the device 900 (e.g., metal-based electronics) from the magnetic field 922 when in various configurations as described herein while respectively directing and/or concentrating magnetic flux toward the coils 920, 921.

As may be appreciated from FIG. 9, each of the coils 920, 921 are respectively electrically coupled to a circuit 926 via at least one respective line 928 and 930, such as via communication lines and/or a power supply lines, or a single line for each coil 920, 921 for both communication and power supply.

The circuit 926 is configured to operatively connect and disconnect from receiving power from each of the coils 920, 921. For instance, the circuit 926 may electrically couple and decouple altogether from each of the coils 920, 921 via lines 928, 930 (e.g., even if still mechanically coupled), and/or may electrically couple and decouple via a power supply line specifically (or a power supply portion of a single line for both communication and power supply) for each of the coils 920, 921 while remaining communicatively coupled thereto, such as for repeated determinations of which of the coils 920, 921 is capable of providing more power in accordance with present principles and switching coils accordingly.

Before moving on in the detailed description, it may be appreciated from FIG. 9 that both of the coils 920, 921 face the same direction relative to the orientation of the panel 902. One or the other of the coils 920, 921 may be capable of receiving more power via the field 922 than the other of the coils 920, 921, and accordingly the coil capable of receiving the most power may be electrically connected to the circuit 926 to provide power thereto while the coil receiving the lesser amount of power may be electrically disconnected from the circuit 926 as disclosed herein.

In the example shown, the coil 920 is nearer to the field 922 than the coil 921 and is understood to be able to provide more power than the coil 921 is able to provide even though both may be affected by the field 922. Thus, the device 900 electrically decouples the circuit 926 from the coil 921 (so that the coil 921 does not provide power to the circuit 926), such as by actuating an electrical bridge or gate in the line 930, based on the coil 920 being able to provide a greater amount of power than the coil 921, and charges a battery in the device 900 using power from the coil 920. In this way, only one coil may provide power from the field 922 to charge the device at any one time since in at least some instances, having two coils providing power to the same circuit at the same time may render the coil non-functional.

Referring again to the barriers 924, 925, they may shield other system components within the panel 902 from the field 922 and hence prevent possible malfunctions of those other components that can be caused by the field 922. The other barriers discussed herein may similarly shield system components from magnetic fields in certain device configurations and/or orientations while directing and/or concentrating flux toward their respective coils. Regardless, note that in some embodiments the barriers 924, 925 (and/or the other barriers discussed herein) may additionally or instead be disposed around other areas within the panel as well to shield one or more system components from the field 922 while one of the coils 920, 921 is used to charge a battery of the device 900. Also note that the barriers 924, 925 (and/or the other barriers discussed herein) may at least substantially shield components from a field such as the field 922 so as to not affect the life and function of the other component(s) being protected even if the field 922 may have some negligible effect on the other component(s)).

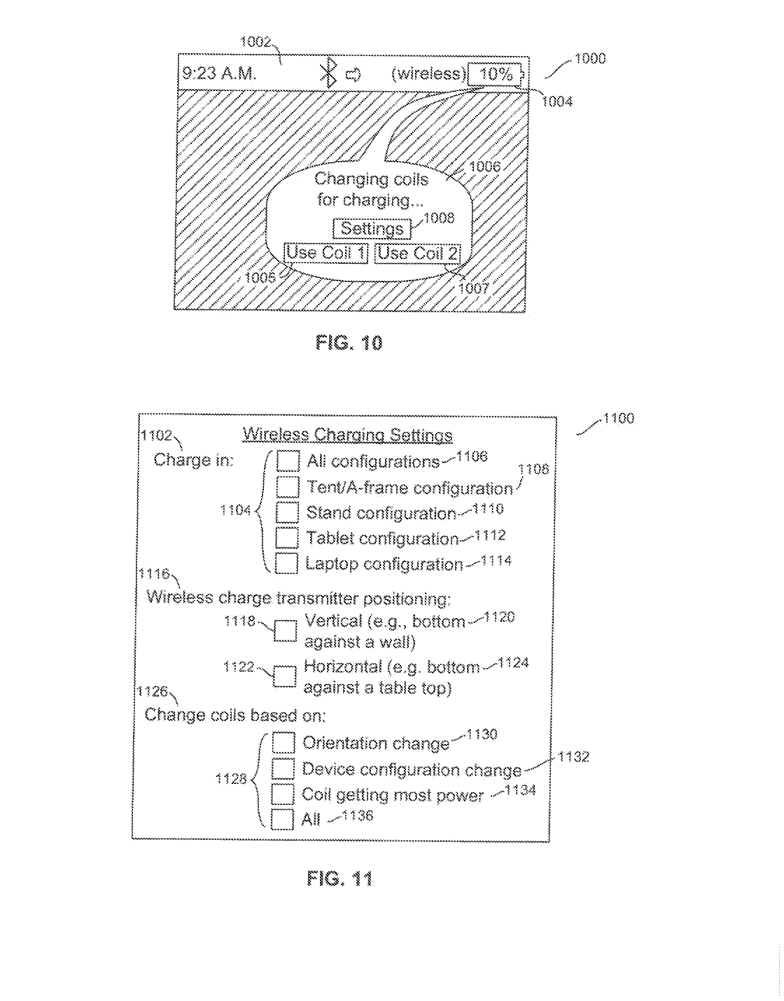

Continuing the detailed description in reference to FIG. 10, a user interface (UI) 1000 presentable on a display of a device such as the system 100 is shown. The UI 1000 includes a top bar 1002 presenting various status information for the system, including a battery charging indicator 1004 indicating that a battery in the device is currently being wirelessly charged and, in the present example, that it has been wirelessly charged up to sixty percent. Also shown on the UI 1000 is a notification 1006 that is as a “thought bubble” in this example as if originating from the indicator 1004. The notification 1006 may be presented responsive to one of the determinations described herein (e.g., such as those described at blocks 306, 402, and 502) to provide an indication of coil switching when and/or while the device changes from one coil in the device being used for wireless charging to another coil in the device to be used for wireless charging. The notification 1006 may include a first selector 1005 selectable by a user to automatically without further user input provide a command to the device to cause the device to use a first coil in the device to provide power to the device and/or charge the device's battery (e.g., regardless of which one of plural coils in the device is currently able to provide more power) as set forth herein, as well as a second selector 1007 selectable by a user to automatically without further user input provide a command to the device to cause the device to use a second coil in the device that is different from the first coil to provide power to the device and/or charge the device's battery as set forth herein. It is to be understood that while the selectors 1005 and 1007 are shown as being presented in the notification 1006, they may instead or additionally be presented on another UI for controlling receipt of wirelessly-provided power in accordance with present principles (e.g., they may be presented on the UI 1100 discussed below) and/or they may be presented on a portion of the device's desktop screen or top bar 1002 itself.

The notification 1006 also includes a settings selector 1008 selectable to present a UI for configuring one or more wireless charge settings in accordance with present principles. Thus, in one example embodiment, selection of the selector 1008 causes the UI 1100 of FIG. 11 to be presented on the display of the device. The UI 1100 includes a first setting 1102 for configuring the device to wirelessly charge its battery when the device is in one or more of the various configurations in which it can be placed. Each of the options to be discussed in the next sentence may be selected to enable wireless charging in the configuration associated with the option using the respective check boxes 1104 for each of the options. The options include an option 1106 to wirelessly charge in all configurations, an option 1108 to wirelessly charge in a tent configuration, an option 1110 to wirelessly charge in a stand configuration, an option 1112 to wirelessly charge in a tablet configuration, and an option 1114 to wirelessly charge in a laptop configuration.

The UI 1100 also includes a second setting 1116 for providing input to the device of which type of wireless charge transmitters will be used to charge the device as discussed herein, such as a vertically-disposed wireless transmitter type (selectable using box 1118 for option 1120) and/or a horizontally-disposed wireless transmitter type (selectable using box 1122 for option 1124). Once this input is received, this information may be used in some embodiments to determine which coil in the device to use to wirelessly charge the device's battery, though one type or the other may be established by the manufacturer of the device as a default.

In addition to the foregoing, the UI 1100 also includes a setting 1126 to enable one or more ways for the device to change which of plural coils is used to charge the device's battery. Each of the options to be discussed in the next sentence may selected using the respective check boxes 1128 for each of the options. The options include an option 1130 to change coils based on a detected change in orientation of the device (e.g., from right side up to upside down even if in the same physical configuration/mode), an option 1132 to change coils based on a detected change in device configuration (e.g., a change in the position of one portion of the device relative to another portion), an option 1134 to change coils based on which coils is capable of providing the most power, and an all option 1136 to change coils based on all of a change in orientation, a change in device configuration, and which coil is capable of providing the most power.

Generally but still in accordance with present principles, it is to be understood that what has been set forth herein may be applied outside the context of the convertible computers described herein and may be used in still other kinds of convertible computers and other types of devices generally (e.g., e-books, tablet computing devices, wireless telephones, home appliances, etc.) for wirelessly charging batteries in those devices.

While the particular WIRELESS CHARGING DEVICE WITH CIRCUIT ELECTRICALLY COUPLABLE TO FIRST AND SECOND COILS is herein shown and described in detail, it is to be understood that the subject matter which is encompassed by the present application is limited only by the claims.

What is claimed is:

1. A device, comprising:
system components;
a battery which supplies power to the system components;
at least one wireless charge receiver that charges the battery while influenced by a magnetic field of a wireless charge transmitter, the at least one wireless charge receiver comprising a circuit coupled to the battery, a first coil coupled to the circuit, and a second coil coupled to the circuit; and
at least one magnetic field barrier at least in part separating the first coil from the second coil.

2. The device of claim 1, wherein the battery is a motor vehicle battery, and wherein the system components comprise:
a vehicle computer system disposed in a vehicle; and
a motor which powers the vehicle.

3. The device of claim 1, comprising a processor and storage.

4. The device of claim 3, wherein the wireless charge receiver charges the battery under control of the processor.

5. The device of claim 4, wherein the wireless charge receiver comprises the processor.

6. The device of claim 4, wherein the processor is a central processing unit (CPU).

7. The device of claim 1, wherein the wireless charge receiver comprises only one circuit.

8. The device of claim 3, wherein the storage is accessible to the processor, and wherein the storage bears instructions executable by the processor to:
determine which of the first coil and the second coil is capable of providing a greater amount of power;
in response to a determination that the first coil is capable of providing a greater amount of power than the second coil, electrically decouple the second coil from providing power to the circuit; and
in response to a determination that the second coil is capable of providing a greater amount of power than the first coil, electrically decouple the first coil from providing power to the circuit.

9. The device of claim 3, wherein the storage is accessible to the processor, and wherein the storage bears instructions executable by the processor to:
identify at least one of an orientation of the device and a physical configuration of one portion of the device relative to another portion of the device; and
at least in part responsive to the identification, electrically decouple one of the first coil and the second coil from providing power to the circuit.

10. The device of claim 1, wherein the circuit electrically decouples the second coil from providing power to the circuit based on the first coil being able to provide a greater amount of power than the second coil, and wherein the circuit electrically decouples the first coil from providing power to the circuit based on the second coil being able to provide a greater amount of power than the first coil.

11. The device of claim 1, comprising at least a first magnetic field barrier disposed adjacent at least to the first coil and a second magnetic field barrier disposed adjacent at least to the second coil.

12. The device of claim 1, wherein the at least one magnetic field barrier comprises a ceramic.

13. The device of claim 1, wherein the at least one magnetic field barrier comprises ferrite.

14. A method, comprising:
electrically decoupling a first coil from providing power to a circuit of a wireless charge receiver based on a first factor; and
electrically decoupling a second coil different from the first coil from providing power to the circuit based on a second factor different from the first factor.

15. The method of claim 14, wherein the first factor is a first orientation of a device in which the wireless charge receiver disposed, and wherein the second factor is a second orientation of the device different from the first orientation.

16. The method of claim 14, wherein the first factor is a first arrangement of a first portion of a device in which the wireless charge receiver is disposed relative to a second portion of the device different from the first portion, and wherein the second factor is a second arrangement of the first portion of the device relative to the second portion that is different from the first arrangement.

17. The method of claim 14, wherein the first factor is the second coil receiving more power wirelessly than the first coil, and wherein the second factor is the first coil receiving more power wirelessly than the second coil.

18. The method of claim 14, wherein the method comprises:
electrically coupling the second coil to the circuit to provide power to the circuit based on the first factor; and
electrically coupling the first coil to the circuit to provide power to the circuit based on the second factor.

19. A wireless charge receiver, comprising:
a first coil and a second coil; and
a circuit operatively coupleable to the first coil and the second coil, wherein the circuit couples and decouples from being able to receive power from the first coil and the second coil based on at least one parameter.

20. The wireless charge receiver of claim 19, comprising:
at least one magnetic field barrier at least in part separating the first coil from the second coil.

21. The wireless charge receiver of claim 19, wherein the at least one parameter comprises one or more of:
an orientation of a device in which the wireless charge device is disposed, and which of the first coil and the second coil is capable of providing more power to the circuit at a particular time.
